(19) United States
(12) Patent Application Publication
(10) Pub. No.: US 2023/0050795 A1
(43) Pub. Date: Feb. 16, 2023

(54) SPEECH RECOGNITION APPARATUS, METHOD AND PROGRAM

(71) Applicant: NIPPON TELEGRAPH AND TELEPHONE CORPORATION, Tokyo (JP)

(72) Inventors: Takafumi MORIYA, Tokyo (JP); Yusuke SHINOHARA, Tokyo (JP)

(73) Assignee: NIPPON TELEGRAPH AND TELEPHONE CORPORATION, Tokyo (JP)

(21) Appl. No.: 17/793,000

(22) PCT Filed: Jan. 16, 2020
(86) PCT No.: PCT/JP2020/001152

§ 371 Date: Jul. 14, 2022

(51) Int. Cl. G10L 15/197; G10L 15/16; G10L 15/22; G10L 15/02; G10L 15/00

(52) U.S. Cl. CPC G10L 15/197; G10L 15/16; G10L 15/22; G10L 15/02; G10L 15/005; G10L 2015/025

(57) ABSTRACT

A score integration unit 7 obtains a new score Score (l_{1:n}^{b, c}) that integrates a score Score (l_{1:n}^{b, c}) and a score Score (w_{1:o}^{b, c}). This new score Score (l_{1:n}^{b, c}) becomes a score Score (l_{1:n}^{b}) in a hypothesis selection unit 8. Thus, the score Score (l_{1:n}^{b}) can be said to take into account the score Score (w_{1:o}^{b, c}). In a speech recognition apparatus, first information is extracted on the basis of the score Score (l_{1:n}^{b}) taking into account the score Score (w_{1:o}^{b, c}). Thus, speech recognition with higher performance than that in the related art can be achieved.

### TECHNICAL FIELD

The present disclosure relates to a speech recognition technology.

### BACKGROUND ART

In speech recognition systems using neural networks in recent years, it is possible to output a word sequence directly from a speech feature. As a learning method for a speech recognition system that outputs a word sequence directly from this acoustic feature, for example, a technique described in NPL 1 is known.

In the technique stated in NPL 1, conversion processing of “acoustic feature⇒phonemic sequence” is performed as processing in the previous stage, and conversion processing of “phonemic sequence⇒word sequence” is performed as processing in the subsequent stage.

### CITATION LIST

### Non Patent Literature

NPL 1: Shiyu Zhou et. al, “Syllable-based Sequence-to-sequence Speech Recognition with the Transformer in Mandarin Chinese,” INTERSPEECH, pp.791-795, 2018

### SUMMARY OF THE INVENTION

### Technical Problem

In the technique stated in NPL 1, the conversion processing of the “acoustic feature⇒phonemic sequence” in the previous stage and the conversion processing of the “phonemic sequence⇒word sequence” in the subsequent stage are performed independently. In other words, in the conversion processing of the “acoustic feature⇒phonemic sequence” in the previous stage, the conversion processing of the “phonemic sequence⇒word sequence” in the subsequent stage is not considered.

An object of the present disclosure is to provide a speech recognition apparatus, a method, and a program with higher speech recognition performance than that in the related-art.

### Means for Solving the Problem

In a speech recognition apparatus according to an aspect of the present disclosure, B and C are predetermined positive integers, b=1, . . . , B and c=1, . . . , C hold, and a hypothesis HypSet(b) includes a first information sequence l_{1:n-1}^{b} from an index 1 to an index n−1 immediately before index n that is currently being processed, and a score Score (l_{1:n-1}^{b}) representing a likelihood of the first information sequence l_{1:n-1}^{b}. The speech recognition apparatus includes: an intermediate feature calculation unit configured to input an input acoustic feature in a predetermined neural network and calculate an intermediate feature; a character feature calculation unit configured to calculate a character feature Lₙ₋₁^{b} corresponding to first information lₙ₋₁^{b} of the index n−1 in a hypothesis b; an output probability distribution calculation unit configured to calculate, using the intermediate feature and the character feature Lₙ₋₁^{b}, an output probability distribution Yₙ^{b} in which a plurality of output probabilities corresponding to respective pieces of the first information are arranged; a first information extraction unit configured to extract first information lₙ^{b, c} having a c-th highest output probability among the output probability distributions Yₙ^{b}, and a score Score (lₙ^{b, c}) that is an output probability corresponding to the first information lₙ^{b, c}; a hypothesis creation unit configured to create a first information sequence l_{1:n}^{b, c} coupling the first information sequence l_{1:n-1}^{b} and the first information lₙ^{b, c}, and a score Score (l_{1:n}^{b, c}) representing a likelihood of the first information sequence l_{1:n}^{b, c}, a first conversion unit configured to convert the first information sequence l_{1:n}^{b, c} into a second information sequence w_{1:o}^{b, c} using a predetermined model, and obtain a score Score (w_{1:o}^{b, c}) representing a likelihood of the second information sequence w_{1:o}^{b, c}; a score integration unit configured to obtain a new score Score (l_{1:n}^{b, c}) that integrates the score Score (l_{1:n}^{b, c}) and the score Score (w_{1:o}^{b, c}); a hypothesis selection unit configured to select B new scores having the high new score Score (l_{1:n}^{b, c}) on a basis of the new score Score (l_{1:n}^{b, c}), and generate a new hypothesis including a plurality of new scores selected and a first information sequence corresponding to the plurality of new scores to set new hypotheses HypSet(1), . . . , HypSet(b) to be used at an index n+1 that is one after the index n that is currently being processed; a control unit configured to repeat processing of the intermediate feature calculation unit, the character feature calculation unit, the output probability distribution calculation unit, the first information extraction unit, the hypothesis creation unit, the first conversion unit, the score integration unit, and the hypothesis selection unit, until a predetermined end condition is satisfied; and a second conversion unit configured to, when the predetermined end condition is satisfied, convert at least a first information sequence l_{k:n}¹ corresponding to a score Score (l_{1:n}¹) having a highest value into a second information sequence w_{1:o}¹, using a predetermined model.

### Effects of the Invention

By taking into account conversion processing of “first information sequence⇒second information sequence” in a subsequent stage in conversion processing of “acoustic feature⇒first information sequence” in a previous stage, speech recognition with higher performance than that in the related-art can be achieved. More particularly, extraction of first information is performed on the basis of a new score Score (l_{1:n}^{b}) considering a score Score (w_{1:o}^{b, c}), speech recognition with higher performance than that in the related art can be achieved.

### BRIEF DESCRIPTION OF DRAWINGS

FIG. 1 is a diagram illustrating an example of a functional configuration of a speech recognition apparatus.

FIG. 2 is a diagram illustrating an example of a processing procedure of a speech recognition method.

FIG. 3 is a diagram illustrating a functional configuration example of a computer.

### DESCRIPTION OF EMBODIMENTS

Hereinafter, an embodiment of a speech recognition apparatus and a speech recognition method will be described with reference to the drawings.

Speech Recognition Apparatus and Speech Recognition Method

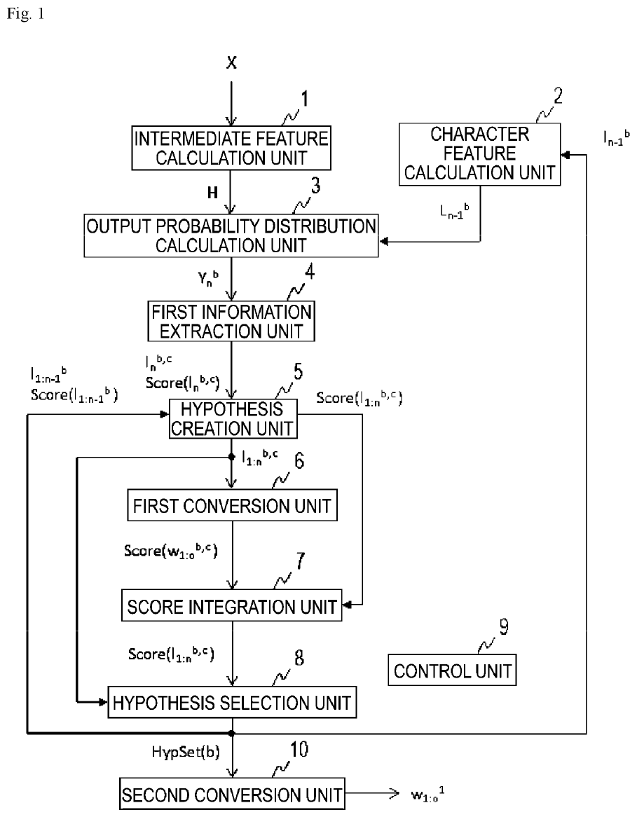

As illustrated in FIG. 1, the speech recognition apparatus includes, for example, an intermediate feature calculation unit 1, a character feature calculation unit 2, an output probability distribution calculation unit 3, a first information extraction unit 4, a hypothesis creation unit 5, a first conversion unit 6, a score integration unit 7, a hypothesis selection unit 8, a control unit 9, and a second conversion unit 10.

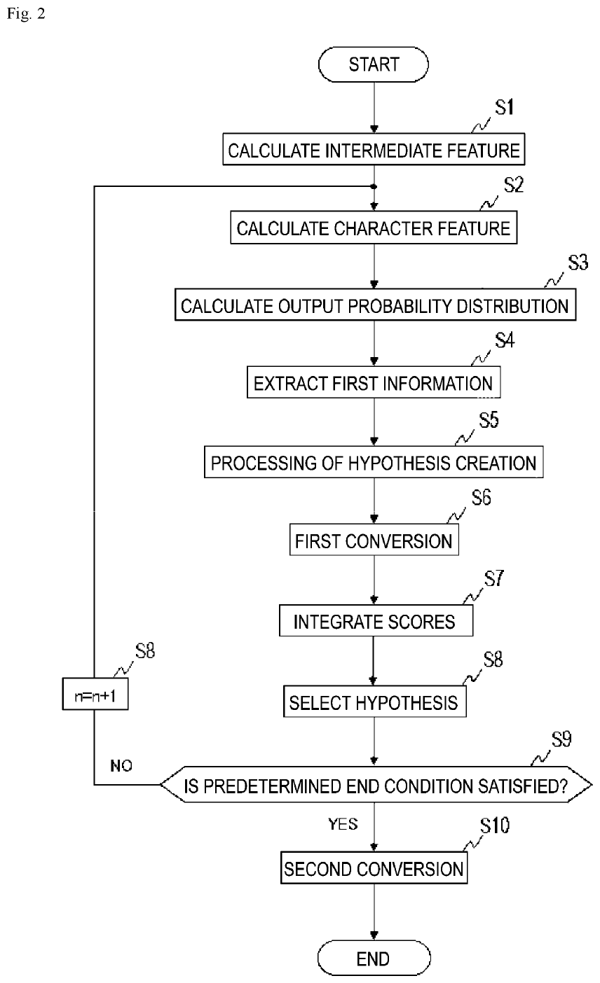

The speech recognition method is achieved, for example, by each component of the speech recognition apparatus performing processing of steps S1 to 10 described below and illustrated in FIG. 2.

Hereinafter, each component of the speech recognition apparatus will be described.

Intermediate Feature Calculation Unit 1

An acoustic feature X is input to the intermediate feature calculation unit 1.

The intermediate feature calculation unit 1 calculates an intermediate feature H by inputting the input acoustic feature X to a predetermined neural network (step S1).

The calculated intermediate feature H corresponding to each piece of the first information is output to the output probability distribution calculation unit 3.

In the following description, information expressed in a first expression format is used as first information, and information expressed in a second expression format is used as second information.

An example of the first information includes a phoneme or a grapheme. An example of the second information includes a word. Here, the words are expressed by alphabetical letters, numbers, symbols in a case of English, and are expressed by hiragana, katakana, kanji, alphabets, numbers, symbols in a case of Japanese. The language corresponding to the first information and the second information may be languages other than English and Japanese.

The first information is a kana sequence, and the second information may be a kana-kanji mixture sequence.

The predetermined neural network is a multi-stage neural network.

The intermediate feature is defined by Equation (1) of Reference 1, for example. Reference 1: G. Hinton, L. Deng, Dong Yu, George E. Dahl, Abdel-rahman Mohamed, Navdeep Jaitly, Andrew Senior, Vincent Vanhoucke, Patric Nguyen, Tara N. Sainath, and Brain Kingsbury, “Deep neural networks for acoustic modeling in speech recognition,” IEEE Signal Processing Magazine, Vol. 29, No. 6, pp. 82-97, 2012.

In general, the main stream for speech recognition is to recognize candidates for various hypotheses while leaving the candidates by the number B of beam widths. Thus, assuming b=1, . . . , B, processing from step S2 to step S7 described below is performed for each b. B is a predetermined positive number.

Character Feature Calculation Unit 2

First information lₙ₋₁^{b} of an index n−1 in a hypothesis b is input to the character feature calculation unit 2.

The character feature calculation unit 2 calculates a character feature Lₙ₋₁^{b} corresponding to the first information lₙ₋₁^{b} of the index n−1 in the hypothesis b (step S2).

The calculated character feature Lₙ₋₁^{b} is output to the output probability distribution calculation unit 3.

When the first information lₙ₋₁^{b} is expressed by a vector such as a one-hot vector, the character feature calculation unit 2 calculates the character feature Lₙ₋₁^{b} by, for example, multiplying a vector corresponding to the first information lₙ₋₁^{b} by a predetermined parameter matrix.

Note that it is assumed that b=1, . . . , B and l₀^{b}=<sos> hold. Here, <sos> is a sentence head symbol.

Output Probability Distribution Calculation Unit 3

The intermediate feature H calculated by the intermediate feature calculation unit 1 and the character feature Lₙ₋₁^{b} calculated by the character feature calculation unit 2 are input to the output probability distribution calculation unit 3.

The output probability distribution calculation unit 3 calculates, using the intermediate feature H and the character feature Lₙ₋₁^{b}, an output probability distribution Yₙ^{b} in which output probabilities corresponding to respective pieces of the first information are arranged (step S3).

The calculated output probability distribution Yₙ^{b} is output to the first information extraction unit 4.

The output probability distribution calculation unit 3 calculates an output probability distribution Yₙ^{b} in which the output probabilities corresponding to each unit of the output layer are arranged by inputting the intermediate feature H and the character feature Lₙ₋₁^{b} to an output layer of the predetermined neural network model. The output probability is, for example, a log probability. The output probability distribution is defined by Equation (2) of Reference 1, for example.

Assuming c=1, . . . , C for a given b, the processing from step S4 to step S7 described below is performed for each c. C is a predetermined positive integer. C may be an integer having the same value as B.

First Information Extraction Unit 4

The output probability distribution Yₙ^{b} calculated by the output probability distribution calculation unit 3 is input to the first information extraction unit 4.

The first information extraction unit 4 extracts first information lₙ^{b, c} having a c-th highest probability of outputting in the output probability distribution Yₙ^{b}, and a score Score (lₙ^{b, c}), which is an output probability corresponding to the first information lₙ^{b, c} (step S4).

The extracted first information lₙ^{b, c} and score Score (lₙ^{b, c}) are output to the hypothesis creation unit 5.

Hypothesis Creation Unit 5

The first information lₙ^{b, c} and the score Score (lₙ^{b, c}) extracted by the first information extraction unit 4 are input to the hypothesis creation unit 5. Further, a first information sequence l_{1:n-1}^{b} up to the index n−1 that is previous one of the index n, selected by the hypothesis selection unit 8 and a score Score (l_{1:n--1}^{b}) representing a likelihood of the first information sequence l_{1:n-1}^{b} are input to the hypothesis creation unit 5.

The hypothesis creation unit 5 creates a first information sequence l_{1:n}^{b, c} in which the first information sequence l_{1:n-1}^{b} and the first information lₙ^{b, c} are coupled, and the score Score (l_{1:n}^{b, c}) representing a likelihood of the first information sequence l_{1:n}^{b, c} (step S5).

The first information sequence l_{1:n}^{b, c} is output to the first conversion unit 6 and the hypothesis selection unit 8. The score Score (l_{1:n}^{b, c}) is output to the score integration unit 7.

The hypothesis creation unit 5 creates the score Score (l_{1:n}^{b, c}) defined by, for example, the following equation.

Score (l_{1:n}^{b, c})=Score (l_{1:n-1}^{b})+Score (lₙ^{b, c})

First Conversion Unit 6

A first information sequence l_{1:n}^{b, c} is input to the first conversion unit 6.

The first conversion unit 6 converts the first information sequence l_{1:n}^{b, c} into a second information sequence w_{1:o}^{b, c} using a predetermined model, and obtains a score Score (w_{1:o}^{b, c}) representing a likelihood of the second information sequence w_{1:o}^{b, c} (step S6).

The score Score (w_{1:o}^{b, c}) is output to the score integration unit 7. o is a positive integer and is the number of pieces of second information.

As the predetermined model, for example, an attention-based model similar to sequence conversion of the acoustic feature⇒phonemic sequence can be used. Further, as the predetermined model, a statistical/neural transliteration model (for example, a model that converts a “kana sequence” which is the first information sequence into a “kana-kanji mixture sequence” which is the second information sequence) described in Reference 2 can be used. [Reference 2] L. Haizhou et. al, “A Joint Source-Channel Model for Machine Transliteration,” ACL, 2004

Score Integration Unit 7

The score Score (l_{1:n}^{b, c}) created by the hypothesis creation unit 5 and the score Score (w_{1:o}^{b, c}) obtained by the first conversion unit 6 are input to the score integration unit 7.

The score integration unit 7 obtains a new score Score (l_{1:n}^{b, c}) that integrates a score Score (l_{1:n}^{b, c}) and the score Score (w_{1:n}^{b, c}) (step S7).

The obtained new score Score (l_{1:n}^{b, c}) is output to the hypothesis selection unit 8.

For example, the score integration unit 7 obtains the new score Score (l_{1:n}^{b, c}) defined by the following equation. Here, λ is a predetermined real number. For example, 0<λ<1.

Score (l_{1:n}^{b, c})=Score (l_{1:n}^{b, c})+λ·Score (w_{1:o}^{b, c})

As described above, assuming B=1, . . . , B, processing from step S2 to step S7 described below is performed for each b. Further, assuming c=1, . . . , C, processing of step S4 to step S7 is performed for each c. Thus, assuming b=1, . . . , b and c=1, . . . , C, a new score Score (l_{1:n}^{b, c}) corresponding to each of B×C sets (b, c) of b, c are obtained.

Hypothesis Selection Unit 8

The new score Score (l_{1:n}^{b, c}) obtained by the score integration unit 7 is input to the hypothesis selection unit 8. Further, the first information sequence l_{1:n}^{b, c} created by the hypothesis creation unit 5 is input to the hypothesis selection unit 8.

On the basis of the new score Score (l_{1:n}^{b, c}), the hypothesis selection unit 8 selects B new scores including the high new score Score (l_{1:n}^{b, c}). Then, the hypothesis selection unit 8 generates a new hypothesis including new scores selected and a first information sequence corresponding to the new score to set this new hypothesis to new hypotheses HypSet(1), . . . , HypSet(B) to be used at the index n+1 that is one after the index n that is currently being processed (step S8).

The generated new hypothesis HypSet(b) is output to the hypothesis creation unit 5 and to the second conversion unit 10. Further, the first information lₙ^{b} in the first information sequence l_{1:n}^{b} included in the created hypothesis HypSet(b) is output to the character feature calculation unit 2.

Here, the first information sequence corresponding to the new score Score (l_{1:n}^{b, c}) is the first information sequence l_{i:n}^{b, c}.

A b-th new score having the high new score Score (l_{1:n}^{b, c}) is expressed as the score Score (l_{1:n}^{b}), and the first information sequence corresponding to the b-th new score having the high new score Score (l_{1:n}^{b, c}) is expressed as the first information sequence l_{1:n}^{b}. With these notations, when b=1, . . . , B holds, the new hypothesis HypSet(b) includes the score Score (l_{1:n}^{b}) and the first information sequence l_{1:n}^{b}. Accordingly, assuming b=1, . . . , B, the new hypothesis HypSet(b) can be expressed as the HypSet(b)=(l_{1:n}^{b}, Score (l_{1:n}^{b})).

At the index n+1 that is one index after the index n that is currently being processed, the HypSet(b)=(l_{1:n}^{b}, the Score (l_{1:n}^{b})) is HypSet(b)=(l_{1:n-1}^{b}, and the Score (l_{1:n-1}^{b})), due to the fact that n is incremented by one. Thus, in FIG. 1, the input of the hypothesis creation unit 5 is expressed as l_{1:n-1}^{b}, Score (l_{1:n-1}^{b}), and the input of the character feature calculation unit 2 is expressed as l_{1:n-1}^{b}.

Control Unit 9

The control unit 9 repeats the processing of the intermediate feature calculation unit 1, the character feature calculation unit 2, the output probability distribution calculation unit 3, the first information extraction unit 4, the hypothesis creation unit 5, the first conversion unit 6, the score integration unit 7, and the hypothesis selection unit 8 until a predetermined end condition is satisfied (step S9).

The predetermined end condition is n=N_{MAX}+1. N_{MAX} is the number of pieces of second information to be output, and is a predetermined positive integer. In this case, the control unit 9 increments n by one after processing of the hypothesis selection unit 8 ends. Then, the control unit 9 determines whether n=N_{MAX}+1 holds, and when n=N_{MAX}+1 holds, the control unit 9 ends the processing of the speech recognition apparatus. When n=N_{MAX}+1 does not hold, the control unit 9 performs control so as to return to the processing in step S2.

Further, the predetermined end condition may be lₙ₋₁^{b}=<eos>. Here, <eos> is an end of sentence symbol.

Second Conversion Unit 10

The new hypotheses HypSet(1), . . . , HypSet(b) generated in the hypothesis selection unit 8 are input to the second conversion unit 10.

When the predetermined end condition is satisfied, the second conversion unit 10 converts at least a first information sequence l_{1:n}¹ corresponding to a score Score (l_{1:n}¹) having a highest value into a second information sequence w_{1:o}¹ using a predetermined model (step S10).

The converted second information sequence w_{1:o}¹ is output from the speech recognition apparatus.

The prescribed model is, for example, the same model as the predetermined model of the first conversion unit 6.

In this manner, by taking into account the conversion processing of the “first information sequence⇒second information sequence” in the subsequent stage in the conversion processing of the “acoustic feature⇒first information sequence” in the previous stage, the present embodiment can achieve speech recognition with higher performance than that in the related art.

More specifically, in the present embodiment, the score integration unit 7 obtains the new score Score (l_{1:n}^{b, c}) that integrates the score Score (l_{1:n}^{b, c}) and the score Score (w_{1:o}^{b, c}). This new score Score (l_{1:n}^{b, c}) becomes the score Score (l_{1:n}^{b}) in the hypothesis selection unit 8. Thus, the score Score (l_{1:n}^{b}) can be said to take into account the score Score (w_{1:o}^{b, c}). By extracting the first information on the basis of the score Score (l_{1:n}^{b}) taking into account this score Score (w_{1:o}^{b, c}), speech recognition with higher performance than in the related-art can be achieved.

Modified Examples

Although the embodiments of the present disclosure have been described above, it is obvious that a specific configuration is not limited to the embodiments, and the present disclosure also includes configurations appropriately changed in the design without departing from the gist of the present disclosure.

The various kinds of processing described in the embodiments are not only implemented in the described order in a time-series manner but may also be implemented in parallel or separately as necessary or in accordance with a processing capability of the apparatus which performs the processing.

For example, data exchange between components of the speech recognition apparatus may be performed directly, or may be performed via a storage unit that is not illustrated.

Program and Recording Medium

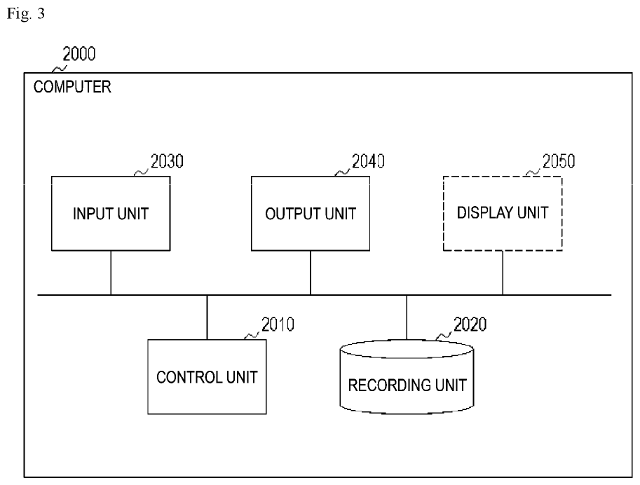

When various processing functions in each apparatus described above are implemented by a computer, processing content of the functions that each apparatus should have is described by a program. In addition, when the program is executed by the computer, the various processing functions of each device described above are implemented on the computer. For example, a variety of processing described above can be performed by causing a recording unit 2020 of the computer illustrated in FIG. 3 to read a program to be executed and causing a control unit 2010, an input unit 2030, an output unit 2040, and the like to execute the program.

The program in which the processing details are described can be recorded on a computer-readable recording medium. The computer-readable recording medium, for example, may be any type of medium such as a magnetic recording device, an optical disc, a magneto-optical recording medium, or a semiconductor memory.

In addition, the program is distributed, for example, by selling, transferring, or lending a portable recording medium such as a DVD or a CD-ROM with the program recorded on it. Further, the program may be stored in a storage device of a server computer and transmitted from the server computer to another computer via a network, so that the program is distributed.

For example, a computer executing the program first temporarily stores the program recorded on the portable recording medium or the program transmitted from the server computer in its own storage device. When executing the processing, the computer reads the program stored in its own storage device and executes the processing in accordance with the read program. Further, as another execution mode of this program, the computer may directly read the program from the portable recording medium and execute processing in accordance with the program, or, further, may sequentially execute the processing in accordance with the received program each time the program is transferred from the server computer to the computer. In addition, another configuration may be employed to execute the processing through a so-called application service provider (ASP) service in which processing functions are implemented just by issuing an instruction to execute the program and obtaining results without transmitting the program from the server computer to the computer. Note that the program in this embodiment includes information used for processing by a computer that is equivalent to the program (data or the like that has characteristics of regulating processing of the computer that is not a direct instruction to the computer).

In addition, although the device is configured by executing a predetermined program on a computer in this mode, at least a part of the processing details may be implemented by hardware.

### REFERENCE SIGNS LIST

1 Intermediate feature calculation unit
2 Character feature calculation unit
3 Output probability distribution calculation unit
4 First information extraction unit
5 Hypothesis creation unit
6 First conversion unit
7 Score integration unit
8 Hypothesis selection unit
9 Control unit
10 Second conversion unit

1. A speech recognition apparatus in which B and C are predetermined positive integers, b=1, . . . , B and c=1, . . . , C hold, and a hypothesis HypSet(b) includes a first information sequence l_{1:n-1}^{b} from an index 1 to an index n−1 immediately before index n that is currently being processed, and a score Score (l_{1:n-1}^{b}) representing a likelihood of the first information sequence l_{1:n-1}^{b}, the speech recognition apparatus comprising a processor configured to execute a method comprising:
iteratively processing, until a predetermined end condition is satisfied, at least:
receiving an input acoustic feature in a predetermined neural network;
calculating an intermediate feature;
calculating a character feature Lₙ₋₁^{b} corresponding to first information lₙ₋₁^{b} of the index n−1 in a hypothesis b;
calculating, using the intermediate feature and the character feature Lₙ₋₁^{b}, an output probability distribution Yₙ^{b} in which a plurality of output probabilities corresponding to respective pieces of the first information are arranged;
extracting first information lₙ^{b, c} having a c-th highest output probability among the output probability distributions Yₙ^{b}, and a score Score (lₙ^{b, c}) that is an output probability corresponding to the first information lₙ^{b, c};
creating a first information sequence l_{1:n}^{b, c} coupling the first information sequence l_{1:n-1}^{b} and the first information lₙ^{b, c}, and a score Score (l_{1:n}^{b, c}) representing a likelihood of the first information sequence l_{1:n}^{b, c};
converting the first information sequence l_{1:n}^{b, c} into a second information sequence w_{1:o}^{b, c} using a predetermined model, and obtain
obtaining a score Score (w_{1:o}^{b, c}) representing a likelihood of the second information sequence w_{1:o}^{b, c};
obtaining a score integration unit configured to obtain a new score Score (l_{1:n}^{b, c}) that integrates the score Score (l_{1:n}^{b, c}) and the score Score (w_{1:o}^{b, c});
selecting B new scores having the high new score Score (l_{1:n}^{b, c}) on a basis of the new score Score (l_{1:n}^{b, c});and
generating a new hypothesis including a plurality of new scores selected and a first information sequence corresponding to the plurality of new scores to set new hypotheses HypSet(1), . . . , HypSet(b) to be used at an index n+1 that is immediately after the index n that is currently being processed; and
when the predetermined end condition is satisfied, converting at least a first information sequence l_{1:n}¹ corresponding to a score Score (l_{1:n}¹) having a highest value into a second information sequence w_{1:0}¹, using a predetermined model.

2. A speech recognition method in which B and C are predetermined positive integers, b=1, . . . , B and c=1, . . . , C hold, and a hypothesis HypSet(b) includes a first information sequence l_{1:n-1}^{b} from an index 1 to an index n−1 immediately before an index n that is currently being processed, and a score Score (l_{1:n-1}^{b}) representing a likelihood of the first information sequence l_{1:n-1}^{b}, the speech recognition method comprising:
iteratively processing, based on a predetermined condition, at least:
inputting an input acoustic feature in a predetermined neural network and calculating an intermediate feature;
calculating a character feature Lₙ₋₁^{b} corresponding to first information lₙ₋₁^{b} of the index n−1 in a hypothesis b;
calculating, using the intermediate feature and the character feature Lₙ₋₁^{b}, an output probability distribution Yₙ^{b} in which a plurality of output probabilities corresponding to respective pieces of the first information are arranged;
extracting first information lₙ^{b, c} having a c-th highest output probability among the output probability distributions Yₙ^{b}, and a score Score (lₙ^{b, c}) that is an output probability corresponding to the first information lₙ^{b, c};
creating a first information sequence l_{1:n-1}^{b}, c coupling the first information sequence _{1:n}^{b, c} and the first information lₙ^{b, c}, and a score Score (l_{1:n}^{b, c}) representing a likelihood of the first information sequence _{1:n}^{b, c};
converting the first information sequence l_{1:n}^{b, c} into a second information sequence w_{1:o}^{b, c} using a predetermined model, and obtain a score Score (w_{1:o}^{b, c}) representing a likelihood of the second information sequence w_{1:o}^{b, c};
obtaining a new score Score (l_{1:n}^{b, c}) that integrates the score Score (l_{1:n}^{b, c}) and the score Score (w_{1:o}^{b, c}); and
selecting B new scores having the high new score Score (l_{1:n}^{b, c}) on a basis of the new score Score (l_{1:n}^{b, c}), and generating a new hypothesis including a plurality of new scores selected and a first information sequence corresponding to the plurality of new scores to set new hypotheses HypSet(1), . . . , HypSet(b) to be used at index n+1 immediately after the index n that is currently being processed; and
when the predetermined end condition is satisfied, converting at least a first information sequence l_{1:n}¹ corresponding to a score Score (l_{1:n}¹) having a highest value into a second information sequence w_{1:o}¹, using a predetermined model.

3. A computer-readable non-transitory recording medium storing computer-executable program instructions that when executed by a processor cause a computer execute a speech recognition method comprising:
wherein B and C are predetermined positive integers, b=1, . . . , B and c=1, . . . , C hold, and a hypothesis HypSet(b) includes a first information sequence from an index 1 to an index n−1 immediately before an index n that is currently being processed, and a score Score (l_{1:n-1}^{b}) representing a likelihood of the first information sequence l_{1:n-1}^{b},
iteratively processing, based on a predetermined condition, at least:
inputting an input acoustic feature in a predetermined neural network and calculating an intermediate feature;
calculating a character feature Lₙ₋₁^{b} corresponding to first information lₙ₋₁^{b} of the index n−1 in a hypothesis b;
calculating, using the intermediate feature and the character feature Lₙ₋₁^{b}, an output probability distribution Yₙ^{b} in which a plurality of output probabilities corresponding to respective pieces of the first information are arranged;
extracting first information lₙ^{b, c} having a c-th highest output probability among the output probability distributions Yₙ^{b}, and a score Score (lₙ^{b, c}) that is an output probability corresponding to the first information lₙ^{b, c};
creating a first information sequence l_{1:n-1}^{b}, c coupling the first information sequence _{1:n}^{b, c} and the first information lₙ^{b, c}, and a score Score (l_{1:n}^{b, c}) representing a likelihood of the first information sequence _{1:n}^{b, c};
converting the first information sequence l_{1:n}^{b, c} into a second information sequence w_{1:o}^{b, c} using a predetermined model, and obtain a score Score (w_{1:o}^{b, c}) representing a likelihood of the second information sequence w_{1:o}^{b, c}.
obtaining a new score Score (l_{1:n}^{b, c}) that integrates the score Score (l_{1:n}^{b, c}) and the score Score (w_{1:o}^{b, c}); and
selecting B new scores having the high new score Score (l_{1:n}^{b, c}) on a basis of the new score Score (l_{1:n}^{b, c}), and generating a new hypothesis including a plurality of new scores selected and a first information sequence corresponding to the plurality of new scores to set new hypotheses HypSet(1), . . . , HypSet(b) to be used at index n+1 immediately after the index n that is currently being processed; and
when the predetermined end condition is satisfied, converting at least a first information sequence l_{1:n}¹ corresponding to a score Score (l_{1:n}¹) having a highest value into a second information sequence w_{1:o}¹, using a predetermined model.

4. The speech recognition apparatus according to claim 1, wherein the predetermined condition is based on a number of pieces of second information for output.

5. The speech recognition apparatus according to claim 1, wherein the predetermined condition is based on an end of sentence feature extracted from the first information.

6. The speech recognition apparatus according to claim 1, wherein the first information includes at least one of a phoneme of a grapheme associated with the input acoustic feature.

7. The speech recognition apparatus according to claim 1, wherein the second information includes a word including a symbol.

8. The speech recognition apparatus according to claim 1, wherein the first information is based on a first language, the second information is based on a second language, and the first language is distinct from the second language.

9. The speech recognition apparatus according to claim 1, wherein the selecting the B new scores having the high new score Score (l_{1:n}^{b, c}) on a basis of the new score Score (l_{1:n}^{b, c}) further includes causing an improvement in performing the extracting first information lₙ^{b, c} during a subsequent iteration of the iterative processing.

10. The speech recognition method according to claim 2, wherein the predetermined condition is based on a number of pieces of second information for output.

11. The speech recognition method according to claim 2, wherein the predetermined condition is based on an end of sentence feature extracted from the first information.

12. The speech recognition method according to claim 2, wherein the first information includes at least one of a phoneme of a grapheme associated with the input acoustic feature.

13. The speech recognition method according to claim 2, wherein the second information includes a word including a symbol.

14. The speech recognition method according to claim 2, wherein the first information is based on a first language, the second information is based on a second language, and the first language is distinct from the second language.

15. The speech recognition method according to claim 2, wherein the selecting the B new scores having the high new score Score (l_{1:n}^{b, c}) on a basis of the new score Score (l_{1:n}^{b, c}) further includes causing an improvement in performing the extracting first information lₙ^{b, c} during a subsequent iteration of the iterative processing.

16. The computer-readable non-transitory recording medium according to claim 3, wherein the predetermined condition is based on a number of pieces of second information for output.

17. The computer-readable non-transitory recording medium according to claim 3, wherein the predetermined condition is based on an end of sentence feature extracted from the first information.

18. The computer-readable non-transitory recording medium according to claim 3, wherein the first information includes at least one of a phoneme of a grapheme associated with the input acoustic feature, and wherein the second information includes a word including a symbol.

19. The computer-readable non-transitory recording medium according to claim 3, wherein the first information is based on a first language, the second information is based on a second language, and the first language is distinct from the second language.

20. The computer-readable non-transitory recording medium according to claim 3, wherein the selecting the B new scores having the high new score Score (l_{1:n}^{b, c}) on a basis of the new score Score (l_{1:n}^{b, c}) further comprises causing an improvement in performing the extracting first information lₙ^{b, c} during a subsequent iteration of the iterative processing.
